(19) United States
(12) Patent Application Publication
(10) Pub. No.: US 2011/0196815 A1
(43) Pub. Date: Aug. 11, 2011

(54) METHODS FOR MANUFACTURING, INVENTORYING, AND SUPPLYING MEDICAL COMPONENTS

(75) Inventors: Dean M.J. Acker, Warsaw, IN (US); Jeffrey D. Brown, Palo Alto, CA (US); Brian D. Earl, South Bend, IN (US); John E. Pendleton, Dunwoody, GA (US)

(73) Assignee: ZIMMER, INC., Warsaw, IN (US)

(21) Appl. No.: 13/123,415

(22) PCT Filed: Oct. 28, 2009
(86) PCT No.: PCT/US09/62319

§ 371 Date: Apr. 8, 2011

Related U.S. Application Data
(62) Division of application No. 61/110,362, filed on Oct. 31, 2008.

(51) Int. Cl. G06Q 90/00

(52) U.S. Cl. 705/500

(57) ABSTRACT

The present invention relates to methods for the manufacturing, inventorying, and supplying of medical components. In one exemplary embodiment, the method includes fabricating individual subcomponents of a modular medical device system as finished goods. The finished subcomponents may then be sterilized, stocked, and inventoried and, upon request from a consumer, the individual subcomponents may be supplied to the consumer. For example, the consumer may be a hospital, a surgeon, or a sales representative. Once the individual subcomponents are received by the consumer, the individual subcomponents may then be assembled by the consumer to form a final, implantable medical device.

### BACKGROUND

1. Field of the Invention

The present invention relates to methods for the manufacturing, inventorying, and supplying of medical components.

2. Description of the Related Art

Medical components are commonly utilized to repair and/or replace damaged bone and/or tissue in the human body. For example, a knee prosthesis may be implanted to replace damaged or destroyed bone in the femur and/or tibia and recreate the natural, anatomical articulation of the knee joint. To implant a prosthesis, orthopedic surgery is performed, which, in some cases, may be a minimally invasive surgery.

To facilitate a minimally invasive surgery, a modular medical device may be used. Modular medical devices have several individual, distinct components that are connected together to form a final, implanted medical device. For example, a femoral unicondylar component may be connected to a patellofemoral component to create a femoral prosthesis in a modular knee prosthesis system. Utilizing a modular medical device allows a surgeon to more accurately replicate the anatomy of a particular patient. However, modular medical devices also significantly increase the number of components that must be machined, inventoried, and delivered to a consumer.

### SUMMARY

The present invention relates to methods for the manufacturing, inventorying, and supplying of medical components. In one exemplary embodiment, the method includes fabricating individual subcomponents of a modular medical device system as finished goods. The finished subcomponents may then be sterilized, stocked, and inventoried and, upon request from a consumer, the individual subcomponents may be supplied to the consumer. For example, the consumer may be a hospital, a surgeon, or a sales representative. Once the individual subcomponents are received by the consumer, the individual subcomponents may then be assembled by the consumer to form a final, implantable medical device.

In another exemplary embodiment, individual modular components of a modular medical device system may be machined and/or fabricated into rough form. The rough form subcomponents may then be maintained in a partially finished state as work in process and the subcomponents inventoried as the same. Upon a request from a consumer for particular subcomponents of the modular device system, additional work may be performed on the subcomponents to finish the modular subcomponents. The finished subcomponents may then be assembled to form a modular medical device that is then sterilized and packaged. The assembled, implantable medical device is then supplied directly to the requesting consumer. Advantageously, by supplying an assembled medical device to the consumer, existing surgical techniques may be utilized to implant the medical device.

In one form thereof, the present invention provides a method of manufacturing and supplying a plurality of subcomponents capable of forming a modular medical device, the method including fabricating into finished goods a plurality of subcomponents configured to be assembled to form a modular medical device; adding the plurality of subcomponents into an inventory as finished goods; receiving a request for at least two of the plurality of subcomponents from a consumer; and supplying the at least two of the plurality of subcomponents requested by the consumer to the consumer.

In another form thereof, the present invention provides a method of manufacturing a modular medical device, the method including fabricating into rough form a plurality of subcomponents configured to be assembled to form a modular medical device; adding the plurality of subcomponents into an inventory as work in process subcomponents; receiving a request from a consumer for the modular medical device including at least two of the plurality of subcomponents; and fabricating the at least two of the plurality of subcomponents requested by the consumer into finished goods.

### BRIEF DESCRIPTION OF THE DRAWINGS

The above-mentioned and other features and advantages of this invention, and the manner of attaining them, will become more apparent and the invention itself will be better understood by reference to the following description of an embodiment of the invention taken in conjunction with the accompanying drawings, wherein:

FIG. 1 is a flowchart for a method according to an exemplary embodiment of the present invention; and

FIG. 2 is a flowchart of methods according to other exemplary embodiments of the present invention.

The exemplifications set out herein illustrate preferred embodiments of the invention and such exemplifications are not to be construed as limiting the scope of the invention in any manner.

### DETAILED DESCRIPTION

Various medical devices are manufactured as modular medical devices, i.e., are manufactured having a plurality individual, discrete subcomponents that are later assembled to form a final, implantable medical device. Additionally, each of the individual subcomponents may be manufactured in different sizes. By creating different sizes, the subcomponents may be selected to form a final, implantable medical device that better matches each individual patient's unique anatomy. For example, one modular medical device system is disclosed as a modular knee prosthesis system in U.S. Pat. No. 7,527,650, entitled “Modular Knee Prosthesis,” filed on Oct. 11, 2007, the entire disclosure of which is expressly incorporated by reference herein. For purposes of exemplification, the present invention is described in detail herein with specific reference to a modular knee prosthesis system. However, the present invention may be applied to any modular medical device or system. In a modular knee prosthesis system, both a modular femoral prosthesis and a modular tibial prosthesis may be provided. To form a modular femoral prosthesis, various subcomponents, such as a medial unicondylar femoral component, a lateral unicondylar femoral component, and a patellofemoral joint component, for example, may be connected together.

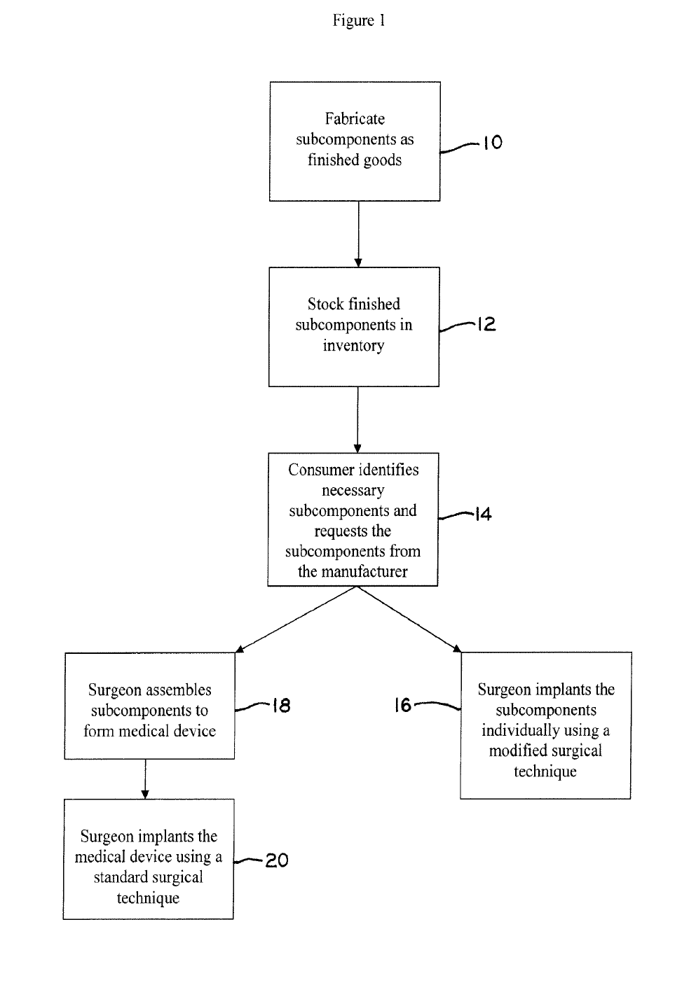

In one exemplary embodiment, each of the individual subcomponents that are assembled to create an implantable medical component, such as medial unicondylar femoral components, lateral unicondylar femoral components, and patellofemoral joint components, are machined into finished goods. As used herein, the term “finished good” denotes that all machining and/or fabrication steps of a subcomponent are complete, exempting other non-manufacturing processes, such as packaging, assembly, or sterilization. In one exemplary embodiment, each individual subcomponent is fabricated into its final, implantable form, as indicated at Step 10 of FIG. 1. This fabrication is performed for each sizing offering of an individual subcomponent, as well as for each of the different types of subcomponents. As a result of the fabrication, each subcomponent of the modular medical device system is in the form of finished goods, as all machining and/or fabrication of the subcomponents is complete.

Referring to Step 12 of FIG. 1, each of the finished subcomponents is then inventoried as a finished good in the manufacturer's inventory system. For example, the finished subcomponents may be inventoried utilizing a bar code system and/or radio frequency tags. Once inventoried, the subcomponents are stored until requested by the consumer. Referring to step 14 of FIG. 1, a consumer may identify the subcomponents that are needed for a prosthesis for a particular patient and submit a request for the identified subcomponents to the manufacturer. The request for the subcomponents may be made in any known manner, such as electronically through the manufacturer's website, by facsimile, or telephonically, for example. In one exemplary embodiment, the consumer is one of a surgeon, a medical treatment facility, such as a surgical center or a hospital, and a sales representative.

Once a request is received by the manufacturer from a consumer, the manufacturer pulls the identified subcomponents from their inventory. Then, any additional steps that are necessary to prepare the subcomponents to be supplied to the consumer, such as sterilization and packing, are performed by the manufacturer. Once the subcomponents are prepared, the subcomponents are supplied to the consumer. In one exemplary embodiment, the subcomponents are supplied to the consumer by shipping the subcomponents to the consumer. Alternatively, in one exemplary embodiment, all of the steps necessary for the preparation of the subcomponents are performed prior to inventorying the subcomponents. In this embodiment, when the request for the subcomponents is received by the manufacturer, the subcomponents are simply pulled from inventory and supplied to the consumer.

Once the subcomponents are supplied to the consumer, the subcomponents are provided to a surgeon. As indicated above, in one exemplary embodiment, the consumer is a surgeon. In this embodiment, the separate step of providing the subcomponents to a surgeon is eliminated. Referring to Step 16, once the subcomponents are provided to a surgeon, the surgeon implants the individual subcomponents utilizing a modified surgical technique. In this embodiment, the surgeon effectively assembles the subcomponents within the patient's body. In another exemplary embodiment, indicated at Step 18, once the subcomponents are provided to the surgeon, the surgeon assembles the subcomponents outside of the patient's body prior to implantation. In this embodiment, the assembled subcomponents form a final modular medical device. Referring to Step 20, once the subcomponents are assembled, the surgeon implants the resulting medical device using a standard surgical technique.

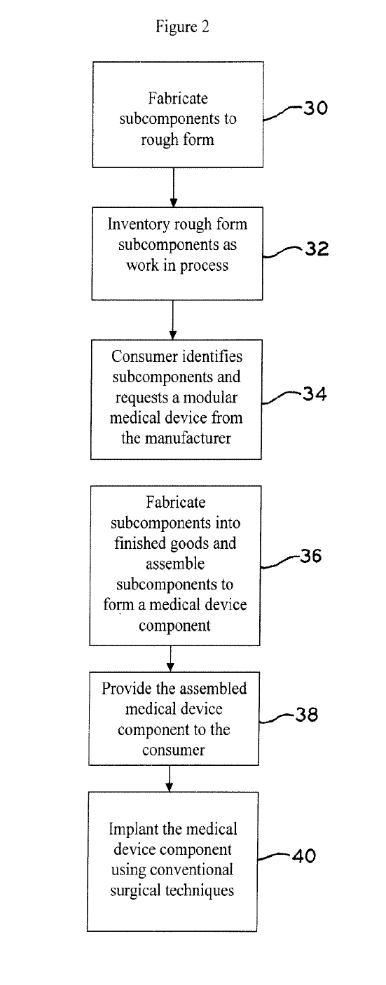

Referring to FIG. 2, another exemplary embodiment of the present invention is described in detail below. As indicated at Step 30 of FIG. 2, in this embodiment of the present invention, each of the individual subcomponents of a modular medical device is fabricated by the manufacturer to a near-net shape or rough form, i.e., additional manufacturing and/or fabrication steps are necessary before the subcomponents are considered “finished goods”. For example, subcomponents for a modular femoral knee prosthesis, such as medial unicondylar femoral components, lateral unicondylar femoral components, and patellofemoral joint components, may be fabricated into a near-net shape or rough form. In one exemplary embodiment, the subcomponents are fabricated to a near-net shape or rough form in which the final form of the subcomponents may be attained with further minimal machining or fabrication in designated areas, for example. However, additional machining and/or fabrication steps are still necessary before the subcomponents are considered to be finished goods.

Referring to Step 32 of FIG. 2, each of the rough form subcomponents are inventoried by the manufacturer as work in process subcomponents using the manufacturer's inventory system. For example, the finished subcomponents may be inventoried utilizing a bar code system and/or radio frequency tags. Referring to Step 34 of FIG. 2, a consumer may than identify the subcomponents that are needed for a prosthesis for a particular patient and submit a request for the identified subcomponents to the manufacturer. The request for the subcomponents may be made in any known manner, such as electronically through the manufacturer's website, by facsimile, or telephonically, for example. In one exemplary embodiment, the consumer is one of a surgeon, a medical treatment facility, such as a surgical center or a hospital, and a sales representative.

Referring to Step 36 of FIG. 2, upon receiving a request for the subcomponents identified by the consumer, additional machining and/or fabrication steps are performed such to transform the subcomponents into finished goods. The subcomponents are then assembled by the manufacturer into a modular medical device as indicated at Step 36 of FIG. 2. Then, any additional steps that are necessary to prepare the subcomponents to be supplied to the consumer, such as sterilization and packing, are performed by the manufacturer.

As indicated at Step 38 of FIG. 2, the assembled, implantable medical device is then supplied to the consumer. In one exemplary embodiment, the medical device is supplied to the consumer by shipping the medical device to the consumer. Upon receipt of the medical device by the consumer, the medical device is provided to a surgeon. As indicated above, in one exemplary embodiment, the consumer is a surgeon. In this embodiment, the separate step of providing the medical device to a surgeon is eliminated. As indicated at Step 40 of FIG. 2, once the medical device is received by the surgeon, the medical device is implanted using the standard surgical techniques for that particular medical device.

Alternatively, in another exemplary embodiment of the present invention, once the subcomponents are fabricated into finished goods at Step 36 of FIG. 2, the subcomponents are not assembled by the manufacturer into a modular medical device. Instead, any additional steps that are necessary to prepare the subcomponents for supplying the subcomponents to the consumer, such as sterilization and packing, are performed by the manufacturer and the subcomponents are supplied to the consumer, such as by shipping, in an unassembled form. Once the subcomponents are provided to a surgeon, the surgeon may then assemble the subcomponents prior to implantation or during implantation in a substantially similar manner as described in detail above with specific reference to the embodiment of FIG. 1.

While this invention has been described as having preferred designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of manufacturing and supplying a plurality of subcomponents capable of forming a modular medical device, the method comprising:
fabricating into finished goods a plurality of subcomponents configured to be assembled to form a modular medical device;
adding the plurality of subcomponents into an inventory as finished goods;
receiving a request for at least two of the plurality of subcomponents from a consumer; and
supplying the at least two of the plurality of subcomponents requested by the consumer to the consumer.

2. The method of claim 1, further comprising, before the supplying step, the step of sterilizing the plurality of subcomponents.

3. The method of claim 2, further comprising, before the supplying step, the step of packaging the at least two of the plurality of subcomponents.

4. The method of claim 1, further comprising, after the supplying step, the step of implanting the at least two of the plurality of subcomponents.

5. The method of claim 1, further comprising, after the receiving step, the step of assembling the at least two of the plurality of subcomponents to form a modular medical device.

6. The method of claim 5, further comprising, after the assembling step, the step of sterilizing the modular medical device, wherein the supplying step further comprises supplying the modular medical device requested by the consumer to the consumer.

7. The method of claim 5, further comprising, after the supplying step, the step of implanting the modular medical device.

8. The method of claim 1, further comprising, before the supplying step, the step of assembling the at least two of the plurality of subcomponents to form a modular medical device.

9. The method of claim 1, wherein the consumer comprises one of a surgeon, a medical treatment facility, and a sales representative.

10. A method of manufacturing a modular medical device, the method comprising:
fabricating into rough form a plurality of subcomponents configured to be assembled to form a modular medical device;
adding the plurality of subcomponents into an inventory as work in process subcomponents;
receiving a request from a consumer for the modular medical device including at least two of the plurality of subcomponents; and
fabricating the at least two of the plurality of subcomponents requested by the consumer into finished goods.

11. The method of claim 10, further comprising, after the fabricating step, the step of assembling the at least two of the plurality of subcomponents requested by the consumer to form the modular medical device.

12. The method of claim 11, further comprising, after the assembling step, the step of sterilizing the modular medical device.

13. The method of claim 11, further comprising, after the assembling step, the step of supplying the modular medical device to the consumer.

14. The method of claim 13, further comprising, after the supplying step, the step of implanting the modular medical device.

15. The method of claim 10, further comprising, after the fabricating step, the step of supplying the at least two of the plurality of subcomponents requested by the consumer to the consumer.

16. The method of claim 10, further comprising, after the fabricating step, the step of sterilizing the at least two of the plurality of subcomponents requested by the consumer.

17. The method of Clam 16, further comprising, after the sterilizing step, the step of supplying the at least two of the plurality of subcomponents to the consumer.

18. The method of claim 17, further comprising, after the supplying step, the step of implanting the at least two of the plurality of subcomponents.

19. The method of claim 10, further comprising, after the fabricating step, the step of packaging the at least two of the plurality of subcomponents requested by the consumer.

20. The method of claim 10, wherein the consumer comprises one of a surgeon, a medical treatment facility, and a sales representative.
